(19) United States
(12) Patent Application Publication
(10) Pub. No.: US 2021/0084599 A1
(43) Pub. Date: Mar. 18, 2021

(54) METHOD AND APPARATUS FOR ADJUSTING TRANSMIT POWER OF CELL IN MULTI-CARRIER SYSTEM

(71) Applicant: Samsung Electronics Co., Ltd., Suwon-si, Gyeonggi-do (KR)

(72) Inventors: Bongchan KIM, Suwon-si (KR); Byoungha YI, Seoul (KR); Hoon HUH, Yongin-si (KR); Jaeyoung LEE, Seoul (KR)

(21) Appl. No.: 16/613,683

(22) PCT Filed: May 23, 2018
(86) PCT No.: PCT/KR2018/005847

§ 371 Date: Nov. 14, 2019

(30) Foreign Application Priority Data
May 22, 2017 (KR) 10-2017-0063113

(51) Int. Cl. H04W 52/34; H04W 52/26; H04W 52/24

(52) U.S. Cl. CPC H04W 52/343; H04W 52/241; H04W 52/267

(57) ABSTRACT

The present invention relates to a method and an apparatus for real-time transmit power control of a base station and, more particularly, to a method and an apparatus for adjusting real-time transmit power of each cell for improving UE throughput in a multi-carrier environment. A method of controlling transmit power of each cell by a server of the present invention comprises the steps of: receiving setting information from a system management server; receiving channel state information and loading-related information from a base station controlling each cell; determining transmit power to be applied to each cell on the basis of the setting information, the channel state information, and the loading-related information; and transmitting the determined transmit power information to the base station controlling each cell.

### TECHNICAL FIELD

The disclosure relates to a method and an apparatus for controlling transmission power of a cell in real time and, more particularly, to a method and an apparatus for adjusting transmission power of each cell in real time in order to improve UE throughput in a multi-carrier environment.

### BACKGROUND ART

The conventional technologies for controlling transmission power include a technology for controlling transmission power of a cell in real time to be suitable for a radio channel and a loading state in order to improve UE throughput, but the corresponding technology does not consider the operation of a base station and a UE within a multi-carrier and Carrier Aggregation (CA) system and does not separate cell types such as a macro or a pico. Further, the corresponding technology has a problem in that a coverage hole by the control of transmission power cannot be resolved.

Accordingly, throughput of the UE can be improved through optimization of integrated transmission power between carriers in a multi-carrier environment. For example, UE throughput can be improved by generating coverage mismatch between carriers (referring to cell area mismatch between carriers) through the control of transmission power and transmitting data to the UE through a carrier having a good radio channel state through distribution of resources based on Proportional Fair (PF) scheduling. Further, in a heterogeneous network (HetNet) environment in which a macro cell and a pico cell coexist as illustrated in FIG. 2, UE throughput can be improved by controlling transmission power in consideration of interference from the pico cell to the macro cell (pico-to-macro interference) and off-loading from the macro cell to the pico cell (macro-to-pico off-loading) according to loading states of the macro cell and the pico cell.

### DISCLOSURE OF INVENTION

### Technical Problem

Accordingly, there is a need of a method of controlling transmission power of a base station in consideration of multi-carrier information such as a radio channel for each carrier and loading-related information, a CA operation, and each cell type in a multi-carrier environment.

### Solution to Problem

In accordance with an aspect of the disclosure, a method of controlling transmission power of each cell by a server is provided. The method includes: receiving configuration information from a system management server; receiving channel state information and loading-related information from a base station controlling each cell; determining transmission power to be applied to each cell, based on the configuration information, the channel state information, and the loading-related information; and transmitting the determined transmission power information to the base station for controlling each cell.

In accordance with another aspect of the disclosure, a server for controlling transmission power of each cell is provided. The server includes: a transceiver configured to transmit and receive a signal to and from a base station for controlling each cell and a system management server; and a controller configured to perform control to receive configuration information from the system management server, receive channel state information and loading-related information from the base station for controlling each cell, determine transmission power to be applied to each cell, based on the configuration information, the channel state information, and the loading-related information, and transmit the determined transmission power information to the base station for controlling each cell.

### Advantageous Effects of Invention

The disclosure describes a method of controlling transmission power of a cell in real time in order to improve UE throughput in a multi-carrier environment. The disclosure includes a method of detecting network quality deterioration by the control of transmission power through network quality monitoring based on network statistics and updating a transmission power control range. Further, the disclosure includes a method of updating a transmission power control range to prevent an SINR from being equal to or smaller than an SINR that causes a communication outage by predicting a signal-to-interference-noise ratio (SINR) according to a change in transmission power. Further, the disclosure describes an apparatus capable of performing the method.

According to the disclosure, it is possible to improve UE throughput by controlling transmission power of a cell in real time in consideration of multi-carrier information such as a radio channel for each carrier, loading-related information, a CA operation, and each cell type without deterioration of a network quality in a multi-carrier environment.

### BRIEF DESCRIPTION OF DRAWINGS

FIG. 1 illustrates a heterogeneous network environment;

FIG. 2 illustrates a procedure of the disclosure;

FIG. 3 illustrates the configuration of the disclosure in a heterogeneous network system;

FIG. 4 illustrates steps of the disclosure;

FIG. 5 illustrates an effect according to determination of transmission power of the disclosure in a heterogeneous network environment;

FIG. 6 illustrates a detailed process of determining transmission power according to the disclosure;

FIG. 7 illustrates a detailed example of determining transmission power for compulsory load balancing;

FIG. 8 illustrates a method by which an optimization server updates a transmission power control range by monitoring a network quality;

FIG. 9 is a block diagram illustrating an optimization server capable of performing the disclosure;

FIG. 10 is a block diagram illustrating a UE capable of performing the disclosure; and

FIG. 11 is a block diagram illustrating a base station capable of performing the disclosure.

### MODE FOR THE INVENTION

Hereinafter, embodiments of the disclosure will be described in detail in conjunction with the accompanying drawings. In the following description of the disclosure, a detailed description of known functions or configurations incorporated herein will be omitted when it may make the subject matter of the disclosure rather unclear. The terms which will be described below are terms defined in consideration of the functions in the disclosure, and may be different according to users, intentions of the users, or customs. Therefore, the definitions of the terms should be made based on the contents throughout the specification.

In addition, in describing the embodiments of the disclosure, a main substance of the disclosure may be applied to even other communication systems that have a similar technical background with a little change in a range that is not largely out of the range of the disclosure, and this may be possible by a determination of a person having a skilled technical knowledge in a technical field of the disclosure.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Here, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

And each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a Field Programmable Gate Array (FPGA) or an Application Specific Integrated Circuit (ASIC), which performs a predetermined function. However, the unit does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, “unit” or divided into a larger number of elements, “unit”. Moreover, the elements and “units” may be implemented to reproduce one or more CPUs within a device or a security multimedia card.

The disclosure describes a method and an apparatus for controlling transmission power of a cell in real time in consideration of multi-carrier information such as radio channel and loading-related information for each carrier, a CA operation, and a type of each cell in a multi-carrier environment.

A network according to the disclosure includes a system management server, a base station for controlling a cell (the base station may control a macro cell and/or a pico cell), and an optimization server. The system management server transfers configuration information of all cells managed by the optimization server to the optimization server. The base station collects required information for a period of a transmission power control algorithm and transfers the collected information to the optimization server. The optimization server determines transmission power of a cell for improving UE throughput on the basis of information collected from the base station and provides the same to the base station again.

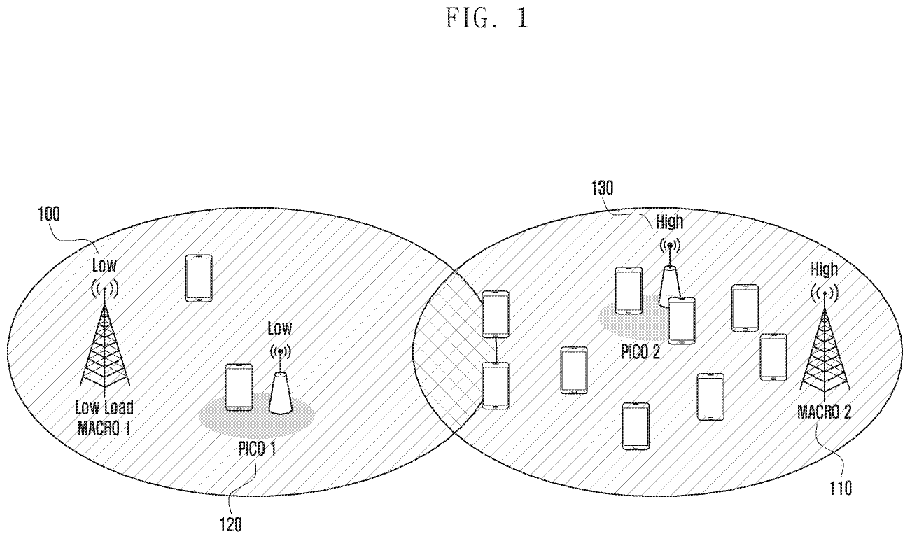

FIG. 1 illustrates a heterogeneous network environment to which the disclosure is applied. Referring to FIG. 1, pico cell #1 120 is located within the coverage of macro cell #1 100, and pico cell #2 130 is located within the coverage of macro cell #2 110. In this case, as described above, it is required to optimize the control of transmission power of the base station in order to increase UE throughput.

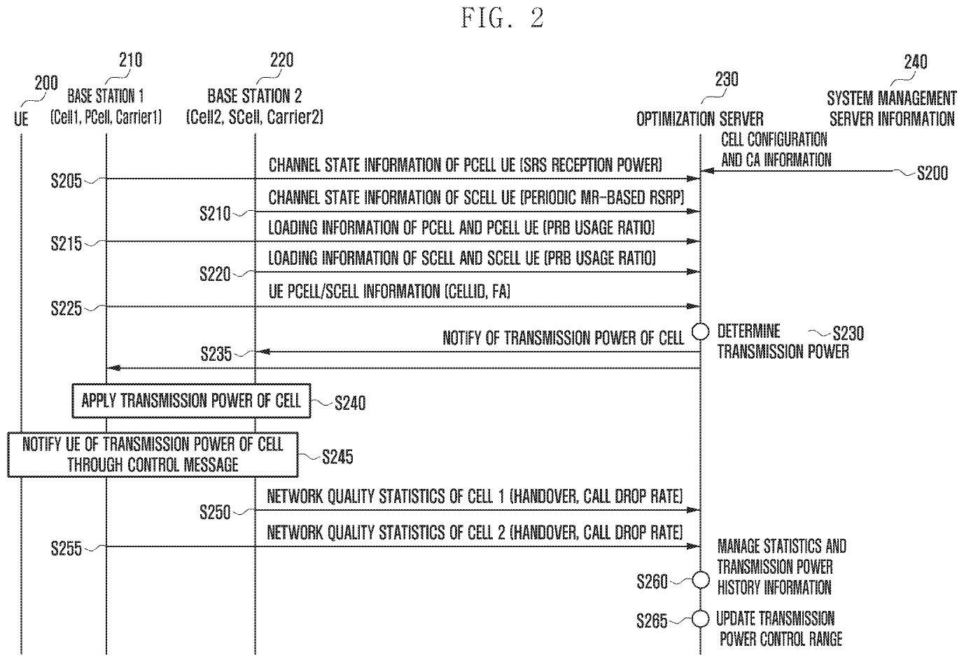

FIG. 2 illustrates a procedure according to the disclosure.

Referring to FIG. 2, it is assumed that a UE 200 is a UE supporting CA, cell #1 is a primary cell (PCell) of the UE, and cell #2 is a secondary cell (SCell) of the UE. At this time, a base station 210 for controlling cell #1 and a base station 220 for controlling cell 2 are located in a network. Further, it is assumed that cell 1 uses carrier 1 and cell 2 uses carrier 2. In the CA operation, the UE receives data on the PCell (cell 1 or carrier 1) and the SCell (cell 2 or carrier 2). The UE is a PCell UE on the side of the PCell and is an SCell UE on the side of the SCell. An optimization server 230 and a system management server 240 are located in the network. Names of such network entities may be different, and respective entities may be located at physically the same location or different locations, but if a network entity performs the following function, the network entity may be understood as the network entity of the disclosure.

A procedure of controlling transmission power of each cell is described below.

The system management server 240 transfers configuration information of all cells managed by the optimization server 230 (for example, a transmission power control range, a transmission power control period, neighbor cell information, a PCell change (change condition), and cell type information) and CA-related information (for example, a collocated cell and SCell addition (add), release, change, activation, and deactivation condition information) to the optimization server 230 in S200. Thereafter, base station #1 210 for controlling cell 1 (PCell or carrier 1) and a base station for controlling a neighbor cell having the same carrier as cell 1 collect radio channel information for the PCell UE (which may be derived from SRS reception power of the base station) through measurement of a sound reference signal (SRS) from the UE and transfer the radio channel information to the optimization server 330 in S205. Although the base station detects a radio channel state through the SRS which the UE transmits in S205, the base station may detect a radio channel state through another reference signal other than the SRS, a pilot signal, or channel status information which the UE transmits and transfer the radio channel state to the optimization server 230. Base station #2 220 for controlling cell 2 (SCell or carrier 2) collects radio channel information for the S Cell UE (for example, reference signal received power (RSRP)) through a periodic measurement report (MR) which the UE transmits and transfers the radio channel information to the optimization server in S210.

Thereafter, base station #1 210 collects loading-related information of the PCell and the PCell UE (for example, a usage ratio of physical resource blocks (PRBs) for a transmission power control period and transfers the loading-related information to the optimization server 230 in S215. Base station #2 220 also collects loading-related information of the SCell and the SCell UE (for example, a usage ratio of PRBs) for a transmission power control period and transfers the loading-related information to the server 230 in S220.

Base station #1 210 transfers information related to the PCell and the SCell of the UE (for example, cell IDs of the PCell and the SCell, and frequency assignment (FA)) to the optimization server 230 in every transmission power control period in S225.

The optimization server 230 determines transmission power of each cell in every transmission power control period on the basis of various channel states collected from base station #1 210 and base station #2 220, loading-related information, CA-related information, cell configuration information, and the cell type in S230. Thereafter, the optimization server transfers the determined transmission power information to base station #1 210 and base station #2 220 in S235.

Base station #1 210 and base station #2 220 receiving the transmission power information applies the corresponding transmission power to cell 1 and cell 2 in S240. Further, base station #1 210 and base station #2 220 transfers the transmission power applied to cell 1 and cell 2 to the UE through a control message in S245. Thereafter, S205 to S245 are repeatedly performed.

The network entities perform the following network quality monitoring procedure in order to prevent deterioration of network quality according to the control of transmission power.

Base station #1 210 collects network quality statistics (for example, handover (HO)-related statistics and call drop statistics) for a transmission power control period and transfers the network quality statistics to the optimization server 230 in S250. Base station #2 220 also collects network quality statistics for a transmission power control period and transfers the network quality statistics to the optimization server 330 in S255. Thereafter, the optimization server 230 manages network quality statistics and history information of transmission power in S260, identifies network quality on the basis of the network quality statistic information, and updates a transmission power control range of the base station of the cell in which the network quality deteriorates in S265. S250 to S265 are repeatedly performed.

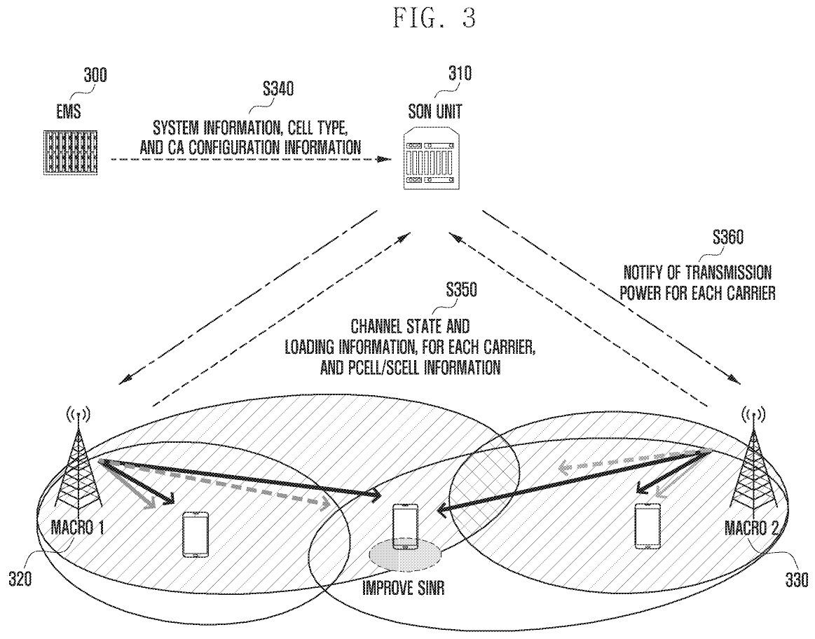

FIG. 3 illustrates the configuration of the disclosure in a heterogeneous network system.

Referring to FIG. 3, an EMS 300 transmits system information, cell type information, and CA configuration information to a SON unit 310 in S340. A base station 320 or 330 for controlling each cell transmits a radio channel state for each carrier, loading-related information for each carrier, and PCell and SCell information to the SON unit 310 in S350. The SON unit 310 determines transmission power to be applied to a cell controlled by each base station on the basis of the received information and provides the transmission power to each base station in S360. At this time, the EMS of FIG. 3 may be understood as the system management server of FIG. 2, and the SON unit of FIG. 3 may be understood as the optimization server of FIG. 2.

Hereinafter, the procedure of the disclosure illustrated in FIGS. 2 and 3 will be described in more detail.

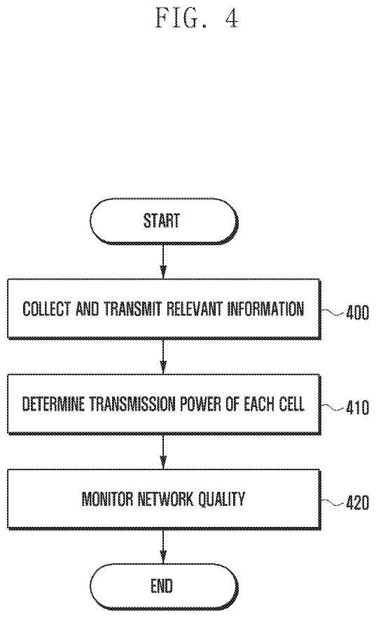

FIG. 4 illustrates steps of the disclosure. Referring to FIG. 4, the disclosure largely includes three steps.

Collect and transmit relevant information in step 400

Determine transmission power of each cell in step 410

Monitor network quality in step 420

Hereinafter, a process of collecting and transmitting information will be described.

The system management server stores configuration information of a cell and transfers configuration information of all cells managed by the optimization server to the optimization server. The cell configuration information is described below.

Transmission power control range minimum transmission power maximum transmission power

Transmission power control period

Cell ID of neighbor cell

PCell change condition: PCell handover condition (for example, Event A3 indicating that a status of a neighbor cell is better than a serving cell by a predetermined offset

Cell type: cell type=macro cell if cell type is macro and cell type=cell if cell type is pico

Further, the system management server stores CA-related information of the cell. The system management server transfers CA-related information of all cells managed by the optimization server to the optimization server. The CA-related information of the cell is described below.

Collocated cell-related information: collocated cell is a cell having the same or a similar coverage area while using a carrier different from that of the corresponding cell

SCell addition condition (for example, Event A4 indicating that a status of a neighbor cell is better than a specific threshold value)

SCell release condition (for example, Event A2 indicating that a serving cell is worse than a specific threshold value)

SCell change condition (for example, Event A6 indicating that a status of a neighbor cell is better than a current SCell by an offset)

SCell activation condition

SCell deactivation condition

The base station for controlling each cell collects channel status information, loading-related information, and CA-related information and transfers the collected information to the optimization server. A detailed procedure for collecting and transmitting information is described below.

A procedure for collecting and transmitting channel status information of the PCell UE is described below.

The base station for controlling the PCell (cell 1 or carrier 1) and base stations for controlling neighbor cells having the same carrier as the PCell measure the SRS of the PCell UE and transfers the SRS to the optimization server.

The optimization server stores radio channel state information between the PCell UE and the PCell and a neighboring cell having a carrier which is the same as that of the PCell on the basis of collected information (SRS reception power).

The PCell UE may transmit an SRS, another reference signal, or a pilot signal to the base station and also transmit channel state information which the PCell UE measures to the base station.

A procedure for collecting channel state information of the SCell UE is described below.

The base station for controlling the SCell (cell 2 or carrier 2) collects RSRP values of the SCell and a neighboring cell having a carrier which is the same as that of the SCell through a periodic measurement report and transfers the collected RSRP values to the optimization server.

The optimization server stores radio channel state information between the SCell UE and the SCell and a neighboring cell having a carrier which is the same as that of the SCell on the basis of collected information (RSRP).

A procedure for collecting loading-related information of the PCell and the PCell UE is described below.

The base station for controlling the PCell calculates a PRB usage ratio of the PCell during a transmission power control period.

The base station for controlling the PCell calculates a PRB usage ratio of the PCell UE during a transmission power control period.

The base station for controlling the PCell transfers PRB usage ratios of the PCell and the PCell UE to the optimization server in every transmission power control period.

The optimization server stores PRB usage ratios of the PCell and the PCell UE.

A procedure of collecting and transmitting loading information of the SCell and the S Cell UE is described below.

The base station for controlling the SCell calculates a PRB usage ratio of the SCell during a transmission power control period.

The base station for controlling the SCell calculates a PRB usage ratio of the SCell UE during a transmission power control period.

The base station for controlling the SCell transfers PRB usage ratios of the SCell and the SCell UE to the optimization server in every transmission power control period.

The optimization server stores PRB usage ratios of the SCell and the SCell UE.

A procedure of collecting and transmitting UE PCell and SCell information is described below.

The base station for controlling the PCell transfers UE PCell and SCell information (cell identifier and FA) to the optimization server in every transmission power control period.

The optimization server stores UE PCell and SCell information.

A procedure for collecting network quality statistics of the cell is described below.

The base station for controlling the cell collects HO-related statistics of the corresponding cell (the number of attempts of HO and the number of successes of HO) during a transmission power control period, call drop-related statistics (the number of successes of connection configuration, the number of successes of hand-in (meaning access to a cell through handover from another cell), and the number of call drops).

The base station for controlling the cell transfers HO statistics and call drop-related statistics to the optimization server in every transmission power control period.

The optimization server manages HO-related statistics of the cell, call drop-related statistics, and history information of transmission power. However, the history information maintains only information for a recent specific time.

Hereinafter, a transmission power determination process to be applied to each base station will be described.

The optimization server determines transmission power to be applied to all cells managed by the optimization server on the basis of multi-carrier information (radio channel state for each carrier, loading-related information, CA-related information, and cell type information) collected from each base station. The optimization server determines transmission power to be applied to each cell to optimize a target value described below while acquiring a load-balancing effect between cells during a transmission power determination process in an aspect of a PRB usage ratio or the number of UEs.

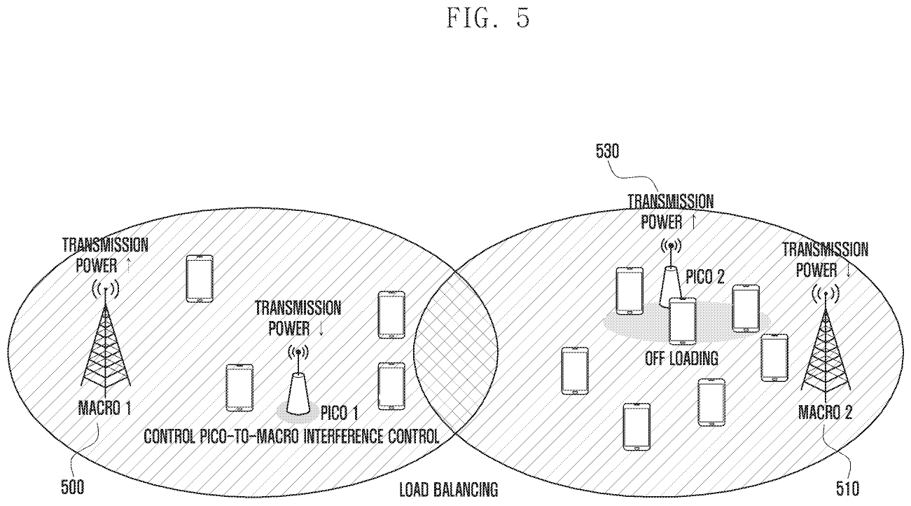

FIG. 5 illustrates an effect according to determination of transmission power of the disclosure in a heterogeneous network environment.

Referring to FIG. 5, power applied to macro cell #1 500 having relatively small load (that is, having the small number of UEs receiving a service) increases and power applied to macro cell #2 510 having relatively large load (that is, having the large number of UEs receiving a service) decreases on the basis of the power control result. Accordingly, load balancing between macro cells is possible, and at this time power of pico cell #1 S20 located within the coverage of macro cell #1 decreases to reduce pico-to-macro interference influencing macro cell #1. Further, power of pico cell #2 S30 located within the coverage of macro cell #2 increases for macro-to-pico offloading.

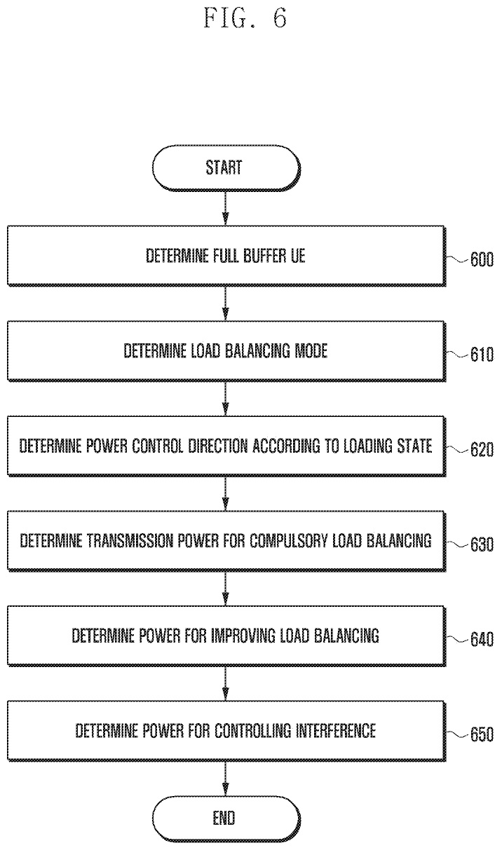

FIG. 6 illustrates a detailed process of determining transmission power according to the disclosure. Referring to FIG. 6, the process of determining transmission power is described below.

Determine a full buffer UE in step 600.

Determine a load-balancing mode in step 610.

Determine a power control direction according to a loading state in step 620.

Determine transmission power for compulsory load balancing in step 630.

Determine power for improving load balancing in step 640.

Determine power for controlling interference in step 650.

Each step of the process of determining transmission power will be described below in detail.

1. Determine a Full Buffer UE.

The optimization server identifies whether the UE is a full buffer UE on the basis of a PRB usage ratio of the cell at the current transmission power (CurrP), a PRB usage ratio of the UE, and capacity information. The full buffer UE is a UE having a large amount of data to be transmitted, and a UE which satisfies all of Equations 1, 2, and 3 below is determined as the full buffer UE.

CellPRBusageRatio_{CurrP,J}_{_{CurrP,m}}≥Threshold_{HighLoadCell} Equation 1

In Equation 1 above, CellPRBusageRatio_{CurrP,j}_{_{CurrP,m}}, denotes a cell PRB usage ratio of a serving cell of a UE m at current transmission power (CurrP), and j_{CurrP,m} denotes a serving cell index of the UE m (that is, index of a PCell or SCell of the UE m) at current transmission power (CurrP). Threshold_{HighLoadCell} is a predetermined value and corresponds to a reference of the cell PRB usage ratio of the serving cell of the UE m at the current transmission power. If the cell PRB usage ratio of the serving cell of the UE m at the current transmission power is higher than Threshold_{HighLoadCell}, the cell may be determined as a cell of high load.

UEPRBusageRatio_{CurrP,j}_{_{CurrP,m}}, m>1/N_{CurrP,j}_{_{CurrP,m}} Equation 2

In Equation 2 above, UEPRBusageRatio_{CurrP,j}_{_{CurrP,m}},m denotes a UE PRB usage ratio of the UE m at the current transmission power (CurrP), and N_{CurrP,j}_{_{CurrP,m}} denotes the number of UEs of the serving cell of the UE m at the current transmission power (CurrP). That is, Equation 2 above means the case in which the PRB usage ratio of the UE m is higher than an average PRB usage ratio of the UE expected in the serving cell j_{CurrP,m} of the UE m.

UEPRBusageRatio _{CurrP,j}_{_{Curr,P,m}},m>FullBufferRatio_{CurrP,j}_{_{CurrP,m}},m Equation 3

FullBufferRatio_{CurrP,j}_{_{CurrP,m}},m denotes a predicted PRB usage rate of the UE m when a cell PRB usage rate of the serving cell of the UE m at current transmission power (CurrP) is 1 and data transmission rates of all UEs within the serving cell of the UE m are the same as each other, and

UEPRBusageRatio_{CurrP,j}_{_{CurrP,m}},m denotes a UE PRB usage rate of the UE m at current transmission power (CurrP). That is, Equation 3 means the case in which a PRB usage ratio of the UE m is larger than a predicted PRB usage ratio of the UE m when a cell PRB usage ratio of the serving cell j_{CurrP,m} is 1.

2. Determine a Load-Balancing Mode

The determination of the load-balancing mode is performed as follows. The optimization server selects a balancing mode of a number of UEs if a PRB usage ratio of all cells managed by the optimization server is larger than or equal to a specific threshold value. Otherwise, the optimization server selects a PRB balancing mode. If the PRB usage ratio of all cells is larger than or equal to the specific threshold value, many transmission resources (PRBs) have been already used and thus UE throughput is increased through the number-of-UE balancing. Otherwise, many transmission resources are not being used and thus UE throughput is increased through the balanced use of transmission resources.

3. Determine a Power Control Direction According to a Loading State

The optimization server determines a power control direction according to a load state of a macro cell within the optimization server. The optimization server decreases power (power down) in order to decrease a load of a macro cell in a high load state, and increases power (power up) in order to increase a load of a macro cell in a low load state. A detailed procedure is described below.

The optimization server calculates a load degree of a macro cell according to Equation 4 below.

LoadDegree=(CellLoad_{Macroj}−AvgOfCellLoad_{Macro})/StdOfCellLoad_{Macro} Equation 4

In Equation 4, CellLoad_{Macro,j} denotes the number of UEs (in the UE balancing mode) of a macro cell j or a PRB usage ratio (in the PRB balancing mode), AvgOfCellLoad_{Macro} denotes an average value of CellLoad_{Macro} of a macro cell within the optimization server, and StdOfCellLoad_{Macro} denotes the standard deviation of CellLoad_{Macro} of a macro cell within the optimization server.

The optimization server determines a power control direction of a macro cell according to Equation 5 below.

If LoadDegree>=1, decrease power of macro cell j (PowerDirectionⱼ=down)

If LoadDegree=<−1, increase power of macro cell j (PowerDirectionⱼ=up)

If the two conditions are not satisfied, there is no limit on a change in power of a macro cell (PowerDirectionⱼ=not limited) Equation 5

If the LoadDegree is larger than 1, a load of the macro cell is high and thus transmission power is decreased, and if the LoadDegree is smaller than −1, a load of the macro cell is low and thus transmission power is increased to make the load larger.

Further, the optimization server determines a power control direction of a pico cell within the optimization server. Transmission power of the pico cell is configured to have no power change regardless of a load state of the pico. That is, PowerDirectionⱼ=not limited.

4. Determine Transmission Power for Compulsory Load Balancing

The optimization server determines transmission power (LoadBalP) for compulsory load balancing according to the power control direction of the cell determined in the above step. Compulsory loading balancing transmission power is transmission power for increasing the number of UEs serviced by a cell corresponding to power direction=up and decreasing the number of UEs serviced by a cell corresponding to power direction=down through a minimum power change. However, when the compulsory loading balancing transmission power is calculated, a cell increasing power is preferentially considered.

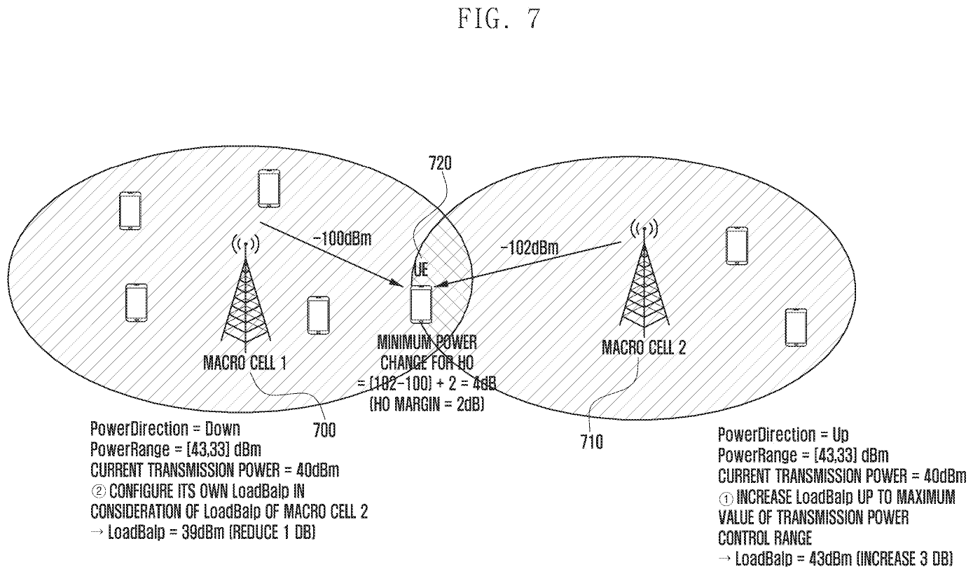

FIG. 7 illustrates a detailed example of determining transmission power for compulsory load balancing.

Referring to FIG. 7, macro cell #1 700 and macro cell #2 710 exist within a network. At this time, a power control direction of macro cell #1 having large load is determined as a down direction, a power control direction of macro cell #2 having small load is determined as up direction, a transmission power control range of both the macro cells is 33 to 43 dBm, and the optimization server determines transmission power for compulsory load balancing as follows when the current transmission power of both macro cells 1 and 2 is 40 dBm.

The optimization server determines a minimum power change (including HO margin) for handover of a UE 720 located at an edge of macro cell #1 and macro cell #2 from macro cell #1 to macro cell #2. For the HO margin, the PCell UE may use a PCell change condition (for example, event A3 condition) and the S Cell UE may use an SCell change condition (for example, event A6 condition).

When an intensity of a signal for the UE of macro cell #1 is −100 dBm and an intensity of a signal for the UE of macro cell #2 is −102 dBm and thus the HO margin is 2 dB, if the minimum power change is determined as (−100+102)+2=4 dB, the optimization server preferentially considers macro cell #2 increasing power. The optimization server configures compulsory load balancing power LoadBalP as a maximum value (that is, 43 dBm) of the transmission power control range of macro cell #2. At this time, the compulsory load balancing power increases by 3 dBm compared to the current transmission power of macro cell #2. LoadBalP of macro cell #1 is determined as 39 dBm by decreasing the current transmission power by 1 dB such that LoadBalP of macro cell #1 has a difference of 4 dB from macro cell #2 in consideration of the power change of macro cell #2.

5. Determine Transmission Power for Improving Load Balancing.

The optimization server determines transmission power applied to each cell through the transmission power determination process for improving load balancing described below.

First, the optimization server configures transmission power control ranges of all cells according to Equation 6 below.

LoadBalP (compulsory load balancing transmission power)>transmission power control range of cell CurrP (current transmission power): LoadBalP to maximum transmission power

LoadBalP<transmission power control range of cell CurrP=minimum transmission power to LoadBalP

LoadBalP==transmission power control range of cell CurrP =minimum transmission power to maximum transmission power Equation 6

Referring to FIG. 7, in the case of macro cell #2 710, LoadBalP is 43 dBm and current transmission power is 40 dBm, and thus the transmission power control range of macro cell #2 is 43 dBm which corresponds to LoadBalP and the maximum transmission power value. In the case of macro cell #1 700, LoadBalP is 39 dBm and current transmission power is 40 dBm, and thus the transmission power control range is from 33 dBm (minimum transmission power) to 39 dBm.

Secondly, the optimization server selects a cell and randomly selects transmission power (P) within the transmission power control range of the selected cell.

Thereafter, thirdly, the optimization server determines a primary cell (PCellp) of the UE at the selected transmission power (P). The following information is used during the PCell_{P} determination process.

Primary cell (PCell_{CurrP}) of the UE at current transmission power (CurrP)

PCell change condition

Channel state information

At this time, when the selected transmission power (P) is applied, if predicted reception power of a BestCell which is a cell having the largest predicted reception power compared to predicted reception power of the PCell_{CurrP} (predicted reception power may be understood as the product of a link gain of a radio channel and transmission power and refers to power of a signal which the UE receives) satisfies the PCell change condition, the optimization server determines PCell_{P} as the BestCell. Otherwise (when the PCell change condition is not satisfied), the optimization server determines the PCell_{P} as the PCell_{CurrP}. At this time, the PCell change condition may be, for example, a PCell handover condition, and Event A3 may be applied.

Fourthly, the optimization server determines a secondary cell of the UE at the selected transmission power (P) (SCell_{P}). The following information is used during the SCell_{P} determination process.

PCell_{P} of the UE, that is, a secondary cell (SCell_{CurrP}) of the UE at current transmission power (CurrP)

Collocated cell of PCellp

SCell addition condition of PCell_{P}

SCell release condition of PCell_{P}

SCell change condition of PCell_{P}

The optimization server determines the SCell_{P} of the UE on the basis of the information through the following method. The optimization server configures TempSCell_{P} as the collocated cell of PCell_{P} or the SCell_{CurrP} and configures the BestCell as a cell having maximum predicted reception power at the selected transmission power (P). When predicted reception power of BestCell is larger than predicted reception power of the configured TempSCell_{P} by a threshold value or more (the threshold value is based on the SCell change condition, for example, Event A6), TempSCell_{P} is changed to and configured as BestCell. Otherwise, TempSCell_{P} is maintained as the collocated cell of the originally configured PCell_{P} or the SCell_{CurrP}.

The optimization server processes SCell release/addition/activation/deactivation as follows after the TempSCell_{P} is configured. If predicted reception power of the TempSCell_{P} or a predicted SINR is equal to or smaller than a threshold value (the threshold value may be based on the SCell release condition, for example, Event A2 condition), the optimization server configures the TempSCell_{P} as NULL. Configuration of NULL means that the TempSCell_{P} is not selected. This is because a channel state of the TempSCell_{P} is not good enough. When the TempSCell_{P} is NULL and there is a cell having predicted reception power or predicted SINR that is larger than or equal to a specific threshold value (the threshold value may be based on the SCell addition condition, for example, Event A4 condition), the cell is a cell having a good channel state and thus is configured as the TempSCellp.

When TempSCell_{P} is not NULL but an amount of the use of the PRB by the UE is equal to or smaller than a specific threshold value (referred to as the SCell activation condition), the optimization server configures the TempSCell_{P} as NULL. When the TempSCell_{P} is not NULL and a predicted channel quality (for example, expressed as the product of a predicted channel quality indicator (CQI) and a predicted rank indicator (RI)) of the UE is equal to or smaller than a threshold value (referred to as the SCell deactivation condition), the TempSCell_{P} is configured as NULL. This is because allocation of more resources to the UE is not needed, and activation of the SCell is not needed if a channel quality of the TempSCell_{P} is not good and thus a service cannot be efficiently provided although the TempSCell_{P} is activated as the SCell and the service is provided to the UE.

Thereafter, the optimization server configures the SCell_{P} as the TempSCell_{P}. At this time, the configuration of the TempSCell_{P} as NULL and the configuration of the SCell_{P} as NULL mean that the S Cell is not selected.

Fifthly, the optimization server calculates an objective at the selected transmission power (P).

When a balancing mode is the balancing mode of the number of UEs, the optimization server calculates SumOfLogUETput_{Full,P} as a target value of the control of transmission power. UETput_{Full,P} is UE throughput predicted when the selected transmission power (P) is applied in a full-loading environment and corresponds to a sum of predicted through put of the PCell_{P} and the SCell_{P} of the UE. The target value SumOfLogUETput_{Full,P} is a sum of Log(UETput_{Full,P}) for all UEs managed by the optimization server when the selected transmission power (P) is applied in the full-loading environment.

UETput_{Full,P} is calculated according to Equation 7 below.

$${UETput}_{Full , P , m} = {\sum }_{{j}_{P , m}} ( {\sum }_{{j}_{P , m}^{′}} \frac{1}{{NumUE}_{{j}_{P , m}^{′}}} ) * ( \frac{{Capacity}_{Full , P , {j}_{P , m} , m}}{{\sum }_{{j}_{m}^{′}} {Capacity}_{Full , P , {j}_{P , m}^{′} , m}} ) * {Capacity}_{Full , P , {j}_{P , m} , m}$$

Equation 7

In Equation 7, j_{P,m} denotes a serving cell index of the UE m at transmission power (P) (cell indexes of the PCell_{P} and the SCell_{P} of the UE m), Capacity _{Full,P,j}_{_{P,m}},m denotes predicted capacity of the UE m for the cell j_{P,m} when transmission power (P) is applied in the full-loading environment, and NumUEⱼ_{_{P,m}},m denotes the number of UEs serviced by the cell j_{P,m} at transmission power (P).

When the balancing mode is a PRB balancing mode, the optimization server calculates SumOfLogTotalUEPRBusageRatio_{P} and SumOfLogUETput_{Partial,P} as target values of the control of power.

SumOfLogTotalUEPRBusageRatio_{P} is sum of Log (TotalEstimatedUEPRBusageRatio_{P}) for all UEs managed by the server at the selected transmission power (P) and is calculated according to Equation 8 below.

$${SumofLogTotalUEPRBusageRatio}_{p} = {Q}_{m} {log}_{10} ( {TotalEstimatedUEPRBusageRatio}_{P , m} ) \qquad Equation 8$$

At this time, TotalEstimatedUEPRBusageRatio_{P,m} which is a predicted total UE PRB usage ratio of the UE is calculated as shown in Equation 9 below.

$${TotalEstimatedUEPRBusageRatio}_{P , m} = {Q}_{{j}_{P , m}} {EstimatedUEPRBusageRatio}_{P , {j}_{P , m} , m} \qquad Equation 9$$

According to Equation 9 above, it is noted that TotalEstimatedUEPRBusageRatio_{P}, is a sum of EstimatedUEPRBusageRatio_{P,m} which is the predicted UE PRB usage ratio of each cell for the UE m. EstitnatedUEPRBusageRatio_{P,j}_{_{P,m}}_{,m} is calculated differently in the case of a full buffer UE and the case of a non-full buffer UE in a partial loading environment.

The predicted PRB usage ratio of the full buffer UE for the serving cell is calculated as shown in Equation 10 below.

EstimatedUEPRBusageRatio_{P,j}_{_{P,m}}_{,m}=AvailablePRBusageRatioForFullBufferUE_{P,j}_{_{P,m}}/N_{FullBufferUE,P,j}_{_{P,m}} Equation 10

In Equation 10, AvailablePRBusageRatioForFullBufferUE_{P,j}_{_{P,m}} is defined as 1-−“sum of EstimatedUEPRBusageRatio_{P,j}_{_{P,m}}ₘ of UEs which are not the full buffer UE” for the cell j_{P,m} when the transmission power (P) is applied. Further, N_{FullBufferUE,P,j}_{_{P,m}} is the number of full buffer UEs for the cell j_{P,m} when the transmission power (P) is applied.

Hereinafter, in the case of the UE which is not the full buffer UE, a method of calculating EstimatedUEPRBusgeRatio_{P,j}_{_{P,m}}_{,m} which is the predicted PRB UE usage ratio in the cell j_{P,m} in a partial loading environment for the UE m will be described.

A predicted data size DataSizeₘ of the UE m in the partial loading environment is a predicted amount of data which the UE m can receive from the PCell_{CurrP} and the SCell_{CurrP}. DataSizeₘ is calculated according to Equation 11 below.

$${DataSize}_{m} = ( {\sum }_{{j}_{CurrP , m}} {UEPRBusageRatio}_{CurrP , {j}_{CurrP , m} , m} ) * ( {\sum }_{{j}_{CurrP , m}} {Capacity}_{Partial , CurrP , {j}_{CurrP , m} , m}^{2} \text{/} {\sum }_{{j}_{m} = 0} {Capacity}_{Partial , CurrP , {j}_{CurrP , m} , m} ) \qquad Equation 11$$

In Equation 11, jCurr_{P,m} denotes a serving cell index of the UE m (cell indexes of the PCEll_{CurrP} and the SCell_{CurrP} of the UE m) at current transmission power (CurrP), and UEPRBusageRatio_{CurrP,j}_{_{CurrP,m}}_{,m} denotes a usage ratio of PRBs which a cell j_{CurrP,m} allocates to the UE m at the current transmission power (CurrP), which corresponds to loading information which the optimization server receives from the Cell j_{CurrP,m.} Capacity_{Partial,Curr,P,j}_{_{CurrP,m}}_{,m} denotes predicted capacity of the UE m for the cell j_{CurrP,m} at the current transmission power (CurrP) in the partial loading environment. DataSizeₘ in Equation 11 is used to calculate TempEstimatedUEPRBusageRatio_{P,j}_{_{P,m}}_{,m}.

TempEstimatedUEPRBusageRatio_{P,j}_{_{P,m}}_{,m} is a temporary predicted UE PRB usage ratio of the UE m for the cell j_{P,m} when the current transmission power (P) is applied in the partial loading environment, and the optimization server calculates TempEstimatedUEPRBusageRatio_{P,j}_{_{P,m}}_{,m} according to Equation 12 below.

$${TempEstimatedUEPRBusageRatio}_{P , {j}_{P , m} , m} = {DataSize}_{m} * \frac{{Capacity}_{Partial , P , {j}_{P , m} , m}}{{\sum }_{{j}_{P , m}^{′}} {Capacity}_{Partial , P , {j}_{P , m}^{′} , m}^{2}} \qquad Equation 12$$

If a sum of the temporary predicted UE PRB usage ratios of UEs which are not the full buffer UE for the serving cell calculated according to Equation 12 above (more specifically, a sum of PRB usage ratios of UEs which are not the full buffer UE within one serving cell) is equal to or smaller than 1, the predicted UE PRB usage ratios of the UEs which are not the full buffer UE are calculated as shown in Equation 13 below.

EstimatedUEPRBusageRatio_{P,j}_{_{P,m}}=TempEstimatedUEPRBusageRatio_{P,j}_{_{P,m}}_{,m} Equation 13

The sum of PRB usage ratios corresponding to 1 means that PRBs are affordably used, the temporary predicted PRB usage ratio may be determined as the predicted UE PRB usage ratio of the UE which is not the full buffer UE.

If the sum of temporary predicted UE PRB usage ratios of the UEs which are not the full buffer UE for the serving cell is larger than or equal to 1 (that is, if a PRB usage ratio larger than or equal to 1 is required to transmit a predicted amount of data), the predicted UE PRB usage ratio EstimatedUEPRBusageRatio_{P,j}_{_{P,m}}_{,m} of the UE which is not the full buffer UE is calculated as shown in Equation 14 below.

If TempEstimatedUEPRBusageRatio_{P.j}_{_{P,m}}_{,m}<1/N_{UE,P,j}_{_{P,m}} Equation 14

then EstimatedUEPRBusageRatio_{P,j}_{_{P,m}}_{,m}

Equation 14 above means that, if it is assumed that the PRB usage ratio of the cell j_{P}, m is 1, the temporary predicted PRB usage ratio may be determined as the predicted UE PRB usage ratio of the UE which is not the full buffer UE when an average PRB usage ratio of the UEs serviced by the cell j_{P,m} is smaller than the calculated temporary predicted PRB usage ratio, that is, Equation 14 means to secure PRBs which can be originally allocated to the UE m.

Otherwise, that is, if TempEstimatedUEPRBusageRatio_{P,j}_{_{P,m}}_{,m}≥1/N_{UE,P,j}_{_{P,m}}, the predicted UE PRB usage ratio of EstimatedUEPRBusageRatio_{P,j}_{_{P,m}}_{,m} of the UE which is not the full buffer UE is calculated according to Equation 15 below.

If TempEstimatedUEPRBusageRatio_{P,J}_{_{P,m}}_{,m} <AvailablePRBusageRatioForWorseUE_{P,j}_{_{P,m}}/N_{WorseUE,P,J}_{_{P,m}}

EstimatedUEPRBusageRatio_{P,J}_{_{P,m}}_{,m}=TempEstimatedUEPRBusageRatio_{P,J}_{_{P,m}}_{,m} Equation 15

Otherwise,

EstimatedUEPRBusageRatio_{P,J}_{_{P,m,}}_{,m}=AvailablePRBusageRatioForWorse UE_{P,j}_{_{P,m}}ₘ/N_{Worse,UE,P,j}_{_{P,m}},

AvailablePRBusageRatioForWorseUE_{P,j}_{_{P,m}}_{,m} in Equation 15 above denotes 1−(sum of EstimatedUEPRBusageRatio_{P,j}_{_{P,m}}_{,m} of UEs of TempEstimatedUEPRBusageRatio_{P,j}_{_{P,m}}ₘ<1/N_{UE,P,j}_{_{P,m}}) for the cell j_{P,m} at the selected transmission power (P), and N_{WorseUE,P,j}_{_{P,m}} denotes the number of UEs which are not the full buffer UE for the cell j_{P,m} at the transmission power (P) but correspond to TempEstimatedUEPRBusageRatio_{P,j}_{_{P,m}}_{,m}≥1/N_{UE,P,j}_{_{P,m}}. That is, N_{WorseUE,P,j}_{_{P,m}} denotes the number of UEs to which more resources should be allocated since the UEs have a predicted PRB usage rate higher than an average UE PRB usage rate and transmit data using more resources due to a poor channel state, AvailablePRBusageRatioForWorseUE_{P,j}_{_{P,m}}_{,m} denotes the remaining resources after the UEs of TempEstimatedUEPRBusageRatio_{P,j}_{_{P,m}}_{,m}<1/N_{UE,P,j}_{_{P,m}} use. Accordingly, EstimatedUEPRBusageRatio_{P,j}_{_{P,m}}_{,m} is determined as TempEstimatedUEPRBusageRatio_{P,j}_{_{P,m}}_{,m} if AvailablePRBusageRatioForWorseUE_{P,j}_{_{P,m}}_{,m}/N_{WorseUE,P,j}_{_{P,m}} which is the remaining resources/the number of UEs having a poor channel state is smaller than TempEstimatedUEPRBusageRatio_{P,j}_{_{P,m}}_{,m}, and, otherwise, EstimatedUEPRBusageRatio_{P,j}_{_{P,m}}_{,m} is determined as AvailablePRBusageRatioForWorseUE_{P,j}_{_{P,m}}_{,m}/N_{WorseUE,P,j}_{_{P,m}} which is the remaining resources/the number of UEs having a poor channel state.

UETput_{Partial,P} which is predicted UE throughput at the selected transmission power (P) in the partial loading environment is a sum of throughput predicted from the PCell_{P} and the SCell_{P} of the UE as shown in Equation 16 below.

$${UETput}_{Partial , P , m} = {\sum }_{{j}_{P , m}} {EstimatedUEPRBusageRatio}_{P , {j}_{P , m} , m} * {Capacity}_{Partial , P , {j}_{P , m} , m} \qquad Equation 16$$

If the selected transmission power (P) is applied in the partial loading environment, UETput_{Partial,P,m} is predicted UE throughput of the U m, j_{P,m} is a serving cell index of the UE m (cell indexes of the PCell_{P} and the SCell_{P} of the UE m) at the transmission power (P), and Capacity_{Partial,P,j}_{_{P,m}}_{,m} is predicted capacity of the UE m for the cell j_{P,m} at the selected transmission power (P) in the partial loading environment in Equation 16.

At this time, SumOfLogUETput_{Partial,P} is a sum of Log (predicted UE throughput) for all UEs managed by the server when the transmission power (P) is applied in the partial loading environment and is expressed as shown in Equation 17 below.

$${SumofLogUETput}_{Partial , P} = {Q}_{m} {log}_{10} ( {UETput}_{Partial , P , m} ) \qquad Equation 17$$

The optimization server determines transmission power for optimizing a target value according to each balancing mode while repeating the first to fifth processes.

If the balancing mode is the balancing mode of the number of UEs, transmission power for maximizing SumOfLogUETput_{Full,P} is determined. However, when at least one of the following constraints is satisfied at the selected transmission power (P), the transmission power (P) is extracted from candidate transmission power values for optimizing the target value.

First, there is a constraint related to load balancing.

VarOfNumUE_{Macro,CurrP}=<VarOfNumUE_{Macro,P} Equation 18

In Equation 18 above, VarOfNumUE_{Macro,P} denotes variance of the predicted number of UEs of all macro cells at transmission power (P). This means that the load balancing of the number of UEs should not be worse when the selected transmission power is applied compared to application of the current transmission power.

VarOfNumUE_{Pico,CurrP,k}=<VarOfNumUE_{Pico,P,k} Equation 19

Equation 19 above is applied only to the case in which a selected cell k is a pico cell. VarOfNumUE_{Pico,P,k} denotes variance of the predicted number of UEs of a pico cell k and neighboring cells of the pico cell k at the selected transmission power (P).

Secondly, there is a constraint related to an SINR.

SINR_{Full,CurrP,m}>SINR_{Full,P,m} and SINR_{outage}>SINR_{Full,P,m} Equation 20

In Equation 20 above, SINR_{Full,P,m} denotes a predicted full loading SINR of the UE m at transmission power (P), and SINR_{outage} denotes an SINR value that may generate a communication outage. That is, this is a condition meaning that the full loading SINR of the UE m should be larger than the case of current transmission power and should be larger than the SINR value that may generate the communication outage.

Thirdly, there is a constraint related to a UE located at an edge.

NumEdgeUE_{CurrP}<NumEdgeUE_{P} Equation 21

In Equation 21 above, NumEdgeUE_{P} denotes the predicted number of PCell UEs existing in a handover (HO) region at transmission power (P). This aims at preventing the number of handovers from being excessively large.

Fourthly, there is a constraint related to UE throughput.

EdgeUETput_{Full,CurrP}>EdgeUETput_{Fully,P} Equation 22

In Equation 22 above, EdgeUETput_{Full,P} denotes predicted bottom 5% UE throughput at transmission power (P) in the full loading environment, which means that throughput of the UE located at the edge should be better than now.

SumOfUETput_{Full,CurrP}>SumOfUETput_{FullyP} Equation 23

In Equation 23, SumOfLogUETput_{Partial,P} is a sum of predicted UE throughput at power (P) in the full loading environment, which means that a sum of throughput of all UEs should be better than now based on the assumption of the full loading environment.

If SINR_{Full,CurrP,m}>SINR_{Full,P,m} and SINR_{outage}>SINR_{Full,P,m,} a transmission power control range of the selected cell may be reduced as shown in Equation 24 below in order to prevent the communication outage.

Transmission power control range of selected cell =(selected transmission power (P) of selected cell+1 [dB]) to maximum transmission power Equation 24

In Equation 24, the minimum value of the transmission power control range is controlled to be currently selected transmission power+1 dB in order to prevent the communication outage, and the optimization server controls again the transmission power within a new control range.

If the balancing mode is the PRB balancing mode, the optimization server determines transmission power for maximizing SumOfLogUETput_{Partial,P} or minimizing SumOfLogTotalUEPRBusageRatio_{P}. However, if at least one of the following constraints is satisfied at the selected transmission power (P), the transmission power (P) is excluded from candidate transmission power values for optimizing the target value.

First, there is a constraint related to load balancing.

VarOfCellPRBusageRatio_{Macro,CurrP}=<VarOfCellPRBusageRatio_{Macro,P} Equation 25

In Equation 25, VarOfCellPRBusageRatio_{Macro,P} denotes variance of predicted PRB usage ratios of all macro cells at transmission power (P), which means that load balancing of the PRB usage rate when the selected transmission power is applied should not be worse than the case in which the current transmission power is applied.

VarOfCellPRBusageRatio_{Pico,CurrP,k}=<VarOfCellPRBusageRatio_{Pico,P,k} Equation 26

Equation 26 above is applied only to the case in which a selected cell k is a pico cell. VarOfCellPRBusageRatio_{Pico,p,k} denotes variance of predicted PRB usage ratios of the pico cell k and neighboring cells of the pico cell k at transmission power (P).

Secondly, there is a constraint related to an SINR.

SINR_{Full,CurrP,m}>SINR_{Full,P,m} and SINR_{outage}>SINR_{Full,P,m} Equation 27

In Equation 27 above, SINR_{Full,P,m} denotes a full loading SINR of the UE m at transmission power (P), and SINR_{outage} denotes an SINR value that may generate a communication outage. This is a condition meaning that the full loading SINR of the UE m should be larger than the case of current transmission power and should be larger than the SINR value that may generate the communication outage.

Thirdly, there is a constraint related to UE throughput.

SumOfLogUETput_{Partial,CurrP}>=SumOfLogUETput_{Partial,P} Equation 28

In Equation 28 above, SumOfLogUETput_{Partial,P denotes a sum of Log (predicted UE throughput) at transmission power (P) in a partial loading environment, which means that the sum of UE throughput should not be smaller than the current state.}

Fourthly, there is a constraint related to a UE located at an edge.

NumEdgeUE_{CurrP}<NumEdgeUE_{P} Equation 29

In Equation 29 above, NumEdgeUE_{P} denotes the predicted number of PCell UEs existing in a handover (HO) region at transmission power (P) and aims at preventing the number of handovers from being large.

If SINR_{Full,CurrP,m}>SINR_{Full,P,m} and SINR_{outage}>SINR_{Full,P,m,} the optimization server may reduce a transmission power control range of the selected cell as shown in Equation 30 below in order to prevent the communication outage.

Transmission power control range of selected cell=(selected power (P) of selected cell+1[dB]) to maximum transmission power Equation 30

In Equation 30, the minimum value of the transmission power control range is controlled to be (currently selected transmission power+1 dB) in order to prevent the communication outage, and the optimization server controls again the transmission power within a new control range.

6. Determine Power for Improving Interference Control

Sixthly, the optimization server determines transmission power for maximizing the target value as follows through transmission power determination for controlling interference. However, the transmission power determination process for controlling interference is performed only when there is no transmission power value for improving the target value compared to current transmission power during the transmission power determination process for load balancing.

The transmission power determination process for controlling interference is almost similar to the transmission power control process for improving load balancing.

Firstly, the optimization server configures transmission power control ranges of all cells according to Equation 31 below.

Power control range of cell minimum transmission power to maximum transmission power Equation 31

The transmission power control range is different from the case of transmission power determination for load balancing according to Equation 31 above.

Secondly, the optimization server selects a cell and randomly selects transmission power (P) within the transmission power control range of the selected cell.

Thereafter, thirdly, the optimization server determines a primary cell (PCellP) of the UE at the selected transmission power (P). The following information is used during the PCellP determination process.

Primary cell of the UE at current transmission power (CurrP) (PCellCurrP)

PCell change condition

Channel state information

At this time, when the selected transmission power (P) is applied, if predicted reception power of a BestCell which is a cell having the largest predicted reception power compared to predicted reception power of a PCell_{CurrP} (predicted reception power may be understood as the product of a link gain of a radio channel and transmission power and refers to power of a signal which the UE receives) satisfies the PCell change condition, the optimization server determines a PCell_{P} as the BestCell. Otherwise (when the PCell change condition is not satisfied), the optimization server determines the PCell_{P} as the PCell_{CurrP}. At this time, the PCell change condition may be, for example, a PCell handover condition, and Event A3 may be applied.

Fourthly, the optimization server determines a secondary cell (SCell_{P}) of the UE at the selected transmission power (P). The following information is used during the SCell_{P} determination process.

PCell_{P} of the UE, that is, a secondary cell of the UE at current transmission power (CurrP) (SCell_{CurrP})

Collocated cell of PCell_{P}

SCell addition condition of PCell_{P}

SCell release condition of PCell_{P}

SCell change condition of PCell_{P}

The optimization server determines the SCell_{P} of the UE on the basis of the information through the following method. The optimization server configures a TempSCell_{P} as the collocated cell of the PCell_{P} or the SCell_{CurrP} and configures a BestCell as a cell having maximum predicted reception power at the selected transmission power (P). When predicted reception power of the BestCell is larger than predicted reception power of the configured TempSCell_{P} by a threshold value or more (the threshold value is based on the SCell change condition, for example, Event A6), the TempSCell_{P} is changed to and configured as the BestCell. Otherwise, the TempSCell_{P} is maintained as the collocated cell of the originally configured PCell_{P} or the SCell_{CurrP}.

The optimization server processes SCell release/addition/activation/deactivation as follows after TempSCellP is configured. If predicted reception power of the TempSCell_{P} or a predicted SINR is equal to or smaller than a threshold value (the threshold value is based on the SCell release condition, for example, Event A2 condition), the optimization server configures the TempSCell_{P} as NULL. Configuration of NULL means that the TempSCell_{P} is not selected. This is because a channel state of the TempSCell_{P} is not good enough. If the TempSCell_{P} is NULL and there is a cell having predicted reception power or predicted SINR that is larger than or equal to a specific threshold value (the threshold value may be based on the SCell addition condition, for example, Event A4 condition), the cell is a cell having a good channel state and thus is configured as the TempSCell_{P}.

If the TempSCell_{P} is not NULL but an amount of the use of the PRB by the UE is equal to or smaller than a specific threshold value (referred to as the SCell activation condition), the optimization server configures the TempSCell_{P} as NULL. If the TempSCell_{P} is not NULL and a predicted channel quality (for example, expressed as the product of a predicted channel quality indicator (CQI) and a predicted rank indicator (RI)) of the UE is equal to or smaller than a threshold value (referred to as the SCell deactivation condition), the TempSCell_{P} is configured as NULL. This is because allocation of more resources to the UE is not needed, and activation of the SCell is not needed if a channel quality of the TempSCell_{P} is not good and thus a service cannot be efficiently provided although the TempSCell_{P} is activated as the SCell and the service is provided to the UE.

Thereafter, the optimization server configures the SCell_{P} as the TempSCell_{P}. At this time, the configuration of the TempSCell_{P} as NULL and the configuration of the SCell_{P} as NULL mean that the S Cell is not selected.

Fifthly, the optimization server calculates an objective at the selected transmission power (P).

When a balancing mode is the balancing mode of the number of UEs, the optimization server calculates SumOfLogUETputFully as a target value of the control of transmission power. UETput_{Full,P} is UE throughput predicted when the selected transmission power (P) is applied in a full-loading environment and corresponds to a sum of predicted through put of the PCell_{P} and the SCell_{P} of the UE. The target value SumOfLogUETput_{Full,P} is a sum of Log(UETput_{Full,P}) for all UEs managed by the optimization server when the selected transmission power (P) is applied in the full-loading environment.

UETputFully is calculated according to Equation 32 below.

$${UETput}_{Full , P , m} = {\sum }_{{j}_{P , m}} ( {\sum }_{{j}_{P , m}^{′}} \frac{1}{{NumUE}_{{j}_{P , m}^{′}}} ) * ( \frac{{Capacity}_{Full , P , {j}_{p , m} , m}}{{\sum }_{{j}_{m}^{′}} {Capacity}_{Full , P , {j}_{P , m}^{′} , m}} ) * {Capacity}_{Full , P , {j}_{P , m} , m} \qquad Equation 32$$

In Equation 32, j_{P,m} denotes a serving cell index of the UE m at transmission power (P) (cell indexes of the PCell_{P} and the SCell_{P} of the UE m), Capacity_{Full,P,j}_{_{P,m}}_{,m} denotes predicted capacity of the UE m for the cell j_{P,m} when transmission power (P) is applied in the full-loading environment, and NumUEⱼ_{_{p,m}}_{,m} denotes the number of UEs serviced by the cell j_{P,m} at transmission power (P).

If the balancing mode is a PRB balancing mode, the optimization server calculates SumOfLogTotalUEPRBusageRatio_{P} and SumOfLogUETput_{Partial,P} as target values of the control of power.

SumOfLogTotalUEPRBusageRatio_{P} is sum of Log (TotalEstimatedUEPRBusageRatio_{P}) for all UEs managed by the server at the selected transmission power (P) and is calculated according to Equation 33 below.

$${SumofLogTotalUEPRBusageRatio}_{P} = {Q}_{m} {log}_{10} ( {TotalEstimatedUEPRBusageRatio}_{P , m} ) \qquad Equation 33$$

At this time, TotalEstimatedUEPRBusageRatio_{P,m} which is a predicted total UE PRB usage ratio of the UE is calculated as shown in Equation 34 below.

$${TotalEstimatedUEPRBusageRatio}_{P , m} = {\sum }_{{j}_{P , m}} {EstimatedUEPRBusageRatio}_{P , {j}_{P , m} , m} \qquad Equation 34$$

According to Equation 34 above, it is noted that TotalEstimatedUEPRBusageRatio_{P,m} is a sum of EstimatedUEPRBusageRatio_{P,j}_{_{P,m}}_{,m} which is the predicted UE PRB usage ratio of each cell for the UE m. EstimatedUEPRBusageRatio_{P,j}_{_{P,m}}_{,m} is calculated differently in the case of a full buffer UE and the case of a non-full buffer UE in a partially loading environment.

The predicted PRB usage ratio of the full buffer UE for the serving cell is calculated as shown in Equation 35 below.

EstimatedUEPRBusageRatio_{P,j}_{_{P,m}}_{,m}=AvadablePRBusageRatioForFullBufferUE_{P,j}_{_{P,m}}_{,m}/N_{FullBufferUE,P,j}_{_{P,m}} Equation 35

In Equation 35, AvailablePRBusageRatioForFullBufferUE_{P,j}_{_{P,m}}_{,m} is defined as 1−“sum of EstimatedUEPRBusageRatio_{P,j}_{_{P,m}}_{,m} of UEs which are not the full buffer UE” for the cell jp, ₘ when the transmission power (P) is applied. Further, N_{FullBufferUE,P,j}_{_{P,m}} is the number of full buffer UEs for the cell j_{P,m} when the transmission power (P) is applied.

Hereinafter, in the case of the UE which is not the full buffer UE, a method of calculating EstimatedUEPRBusageRatio_{P,j}_{_{P,m}}_{,m} which is the predicted PRB UE usage ratio in the cell j_{P,m} in a partial loading environment for the UE m will be described.

A predicted data size DataSizeₘ of the UE m in the partial loading environment is a predicted amount of data which the UE m can receive from the PCell_{CurrP} and the SCell_{CurrP}. DataSizeₘ is calculated according to Equation 36 below.

$${DataSize}_{m} = ( {\sum }_{{j}_{CurrP , m}} {UEPRBusageRatio}_{CurrP , {j}_{CurrP , m} , m} ) * ( {\sum }_{{j}_{CurrP , m}} {Capacity}_{Partial , CurrP , {j}_{CurrP , m} , m}^{2} \text{/} {\sum }_{{j}_{m} = 0} {Capacity}_{Partial , CurrP , {j}_{CurrP , m} , m} ) \qquad Equation 36$$

In Equation 36, jCurr_{P,m} denotes a serving cell index of the UE m (cell indexes of the PCEll_{CurrP} and the SCell_{CurrP} of the UE m) at current transmission power (CurrP), and UEPRBusageRatio_{CurrP,j}_{_{CurrP,m}}ₘ denotes a usage ratio of PRBs which a cell j_{CurrP,m} allocates to the UE m at the current transmission power (CurrP), which corresponds to loading information which the optimization server receives from the Cell j_{CurrP, m}. Capacity_{Partial,CurrP,j}_{_{CurrP,m}}_{,m} denotes predicted capacity of the UE m for the cell jcurrp, m at the current transmission power (CurrP) in the partial loading environment. DataSize_{m in Equation} 36 is used to calculate TempEstimatedUEPRBusageRatio_{P,j}_{_{P,m}}_{,m} .

TempEstimatedUEPRBusageRatio_{P,j}_{_{P,m}} TempEstimatedUEPRBusageRatio_{P,j}_{_{P,m}}_{,m} is a temporary predicted UE PRB usage ratio of the UE m for the cell j_{P,m} when the current transmission power (P) is applied in the partial loading environment, and the optimization server calculates TempEstimatedUEPRBusageRatio_{P,j}_{_{P,m}}_{,m} according to Equation 37 below.

$${TempEstimatedUEPRBusageRatio}_{P , {j}_{P , m} , m} = {DataSize}_{m} * \frac{{Capacity}_{Partial , P , {j}_{P , m} , m}}{{\sum }_{{j}_{P , m}^{′}} {Capacity}_{Partial , P , {j}_{P , m}^{′} , m}^{2}} \qquad Equation 37$$

If a sum of the temporary predicted UE PRB usage ratios of UEs which are not the full buffer UE for the serving cell calculated according to Equation 37 above (more specifically, a sum of PRB usage ratios of UEs which are not the full buffer UE within one serving cell) is equal to or smaller than 1, the predicted UE PRB usage ratio EstimatedUEPRBusageRatio_{P,j}_{_{P,m}}_{,m} of the UE which is not the full buffer UE is calculated as shown in Equation 38 below.

EstimatedUEPRBusageRatio_{P,j}_{_{P,m}}_{,m}=TempEstimatedUEPRBusageRatio_{P,j}_{_{P,m}}_{,m} Equation 38

The sum of PRB usage ratios corresponding to 1 means that PRBs are affordably used, so that the temporary predicted PRB usage rate may be determined as the predicted UE PRB usage ratio of the UE which is not the full buffer UE.

If a sum of temporary predicted UE PRB usage ratios of UEs which are not the full buffer UE for the serving cell is larger than or equal to 1 (that is, if a PRB usage ratio larger than or equal to 1 is required to transmit a predicted amount of data), the predicted UE PRB usage ratio EstimatedUEPRBusageRatio_{P,j}_{_{P,m}}_{,m} of the UE which is not the full buffer UE is calculated as shown in Equation 39 below.

If TempEstimatedUEPRBusageRatio_{P,j}_{_{P,m}}_{,m}<1/N_{UE,P,j}_{_{P,m}}, then

EstimatedUEPRBusageRatio_{P,j}_{_{P,m}}_{,m}=TempEstimatedUEPRBusageRatio_{P,j}_{_{P,m}}_{,m} Equation 39

Equation 39 above means that, if it is assumed that the PRB usage ratio of the cell j_{P}, m is 1, the temporary predicted PRB usage ratio may be determined as the predicted UE PRB usage ratio of the UE which is not the full buffer UE when an average PRB usage ratio of the UEs serviced by the cell j_{p,m} is smaller than the calculated temporary predicted PRB usage ratio, that is, Equation 39 means to secure PRBs which can be originally allocated to the UE m.

Otherwise, that is, if TempEstimatedUEPRBusageRatio_{P,j}_{_{P,m}}_{,m}≥1/N_{UE,P,j}_{_{P,m}}, the predicted UE PRB usage rate EstimatedUEPRBusageRatio_{P,j}_{_{P,m}}_{,m} of the UE which is not the full buffer UE is calculated according to Equation 40 below.

If TempEstimatedUEPRBusageRatio_{P,J}_{_{P,m}}_{,m}<AvailablePRBusageRatioForWorseUE_{P,J}_{_{P,m}}_{,m}/N_{WorseUE,Pj}_{_{P,m}} EstimatedUEPRBusageRatio_{P,J}_{_{P,m}}_{,m}=TempEstimatedUEPRBusageRatio_{P,j}_{_{P,m}}_{,m},

Otherwise,

EstimatedUEPRBusageRatio_{P,J}_{_{P,m}}_{,m}=AvailablePRBusageRatioForWorse UE_{P,J}_{_{P,m}}_{,m}/N_{Worse,p,j}_{_{P,m}} Equation 40

AvailablePRBusageRatioForWorseUE_{P,j}_{_{P,m}}_{,m} in Equation 40 above denotes 1−(sum of EstimatedUEPRBusageRatio_{P,j}_{_{P,m}} of UEs of TempEstimatedUEPRBusageRatio_{P,j}_{_{P,m}}_{,m}<1/N_{UE,P,j}_{_{P,m}}) for the cell J_{P,m} at the selected transmission power (P), and N_{WorseUEmP,j}_{_{P,m}} denotes the number of UEs which are not the full buffer UE for the cell j_{P,m} at the transmission power (P) but correspond to

TempEstimatedUEPRBusageRatio_{P,j}_{_{P,m}}_{,m}≥1/N_{UE,P,j}_{_{P,m}}. That is, N_{WorseUE,P,j}_{_{P,m}} denotes the number of UEs to which more resources should be allocated since the UEs have a predicted PRB usage rate higher than an average UE PRB usage rate and transmit data using more resources due to a poor channel state, AvailablePRBusageRatioForWorseUE_{P,j}_{_{P,m}}_{,m} denotes the remaining resources after the UEs of TempEstimatedUEPRBusageRatio_{P,j}_{_{P,m}}_{,m}<1/N_{UE,P,j}_{_{P,m}} use. Accordingly, EstimatedUEPRBusageRatio_{P,j}_{_{P,m}}_{,m} is determined as TempEstimatedUEPRBusageRatio_{P,j}_{_{P,m}}_{,m} if AvailablePRBusageRatioForWorseUE_{P,j}_{_{P,m}}_{,m}/N_{WorseUE,P,j}_{_{P,m}} which is the remaining resources/the number of UEs having a poor channel state is smaller than TempEstimatedUEPRBusageRatio_{P,j}_{_{P,m}}_{,m}, and, otherwise, EstimatedUEPRBusageRatio_{P,j}_{_{P,m}}_{,m} is determined as AvailablePRBusageRatioForWorseUE_{P,j}_{_{P,m}}_{,m}/N_{WorseUE,P,j}_{_{P,m}} which is the remaining resources/the number of UEs having a poor channel state.

UETput_{Partial,P} which is predicted UE throughput at the selected transmission power (P) in the partial loading environment is a sum of throughput predicted from the PCell_{P} and the SCell_{P} of the UE as shown in Equation 41 below.

$${UETput}_{Partial , P , m} = {\sum }_{{j}_{P , m}} {EstimatedUEPRBusageRatio}_{P , {j}_{P , m} , m} * {Capacity}_{Partial , P , {j}_{P , m} , m} \qquad Equation 41$$

If the selected transmission power (P) is applied in the partial loading environment, UETput_{Partial,P,m} is predicted UE throughput of the U m, j_{P,m} is a serving cell index of the UE m (cell indexes of the PCell_{P} and the SCell_{P} of the UE m) at the transmission power (P), and Capacity_{Partio,P,j}_{_{P,m}}_{,m} is predicted capacity of the UE m for the cell j_{P,m} at the selected transmission power (P) in the partial loading environment.

At this time, SumOfLogUETput_{Partial, P} is a sum of Log (predicted UE throughput) for all UEs managed by the server when the transmission power (P) is applied in the partial loading environment and is expressed as shown in Equation 42 below.

$${SumoflogUETput}_{Partial , P} = {Q}_{m} {log}_{10} ( {UETput}_{Partial , P , m} ) \qquad Equation 42$$

The optimization server determines transmission power for optimizing a target value according to each balancing mode while repeating the first to fifth processes.

If the balancing mode is the balancing mode of the number of UEs, transmission power for maximizing SumOfLogUETput_{Full,P} is determined. However, when at least one of the following constraints is satisfied at the selected transmission power (P), the transmission power (P) is extracted from candidate transmission power values for optimizing the target value.

First, there is a constraint related to load balancing.

VarOfNumUE_{Macro,CurrP}<VarOfNumUE_{Macro,P} Equation 43

In Equation 43 above, VarOfNumUE_{Macro,P} denotes variance of the predicted number of UEs of all macro cells at transmission power (P). At this time, a difference between Equation 18 and Equation 43 for determining transmission power for load balancing is that Equation 43 does not include the sing of equality. This means that the load balancing of the number of UEs should become better for interference control.

VarOfNumUE_{Pico,CurrP,k}=<VarOfNumUE_{Pico,P,k} Equation 44

Equation 44 above is applied only to the case in which a selected cell k is a pico cell. VarOfNumUE_{Pico,P,k} denotes variance of the predicted number of UEs of a pico cell k and neighboring cells of the pico cell k at the selected transmission power (P). At this time, a difference between Equation 19 and Equation 44 for determining transmission power for loading balancing is that Equation 44 does not include the sign of equality. This means that the load balancing of the number of UEs should become better for interference control.

Secondly, there is a constraint related to an SINR.

SINR_{Full,CurrP,m}>SINR_{Full,P,}m and SINR_{outage}>SINR_{Full,P,m} Equation 45

In Equation 45 above, SINR_{Full,P,m} denotes a predicted full loading SINR of the UE m at transmission power (P), and SINR_{outage} denotes an SINR value that may generate a communication outage. That is, this means that the full loading SINR of the UE m should be larger than the case of current transmission power and should be larger than the SINR value that may generate the communication outage.

Thirdly, there is a constraint related to a UE located at an edge.

NumEdgeUE_{CurrP}<NumEdgeUE_{P} Equation 46

In Equation 46 above, NumEdgeUE_{P} denotes the predicted number of PCell UEs existing in a handover (HO) region at transmission power (P). This aims at preventing the number of handovers from being excessively large.

Fourthly, there is a constraint related to UE throughput.

EdgeUETput_{Full,CurrP}>EdgeUETput_{Full,P} Equation 47

In Equation 47 above, EdgeUETput_{Full,P} denotes predicted bottom 5% UE throughput at transmission power (P) in the full loading environment, which means that throughput of the UE located at the edge should become better than now.

SumOfUETput_{FullCurrP}>SumOfUETput_{Full,P} Equation 48

In Equation 48, SumOfLogUETput_{Partial,P} is a sum of predicted UE throughput at power (P) in the full loading environment, which means that a sum of throughput of all UEs should be better than now based on the assumption of the full loading environment.

If SINR_{Full,CurrP,}m>SINR_{Full,P,m} and STNIR_{outage}>SINR_{Full,P,m,} a transmission power control range of the selected cell may be reduced as shown in Equation 49 below in order to prevent the communication outage.

Transmission power control range of selected cell=(selected transmission power (P) of selected cell +1[dB]) to maximum transmission power Equation 49

In Equation 49, the minimum value of the transmission power control range is controlled to be currently selected transmission power+1 dB in order to prevent the communication outage, and the optimization server controls again the transmission power within a new control range.

If the balancing mode is the PRB balancing mode, the optimization server determines transmission power for maximizing SumOfLogUETput_{Partial,P} or minimizing SumOfLogTotalUEPRBusageRatio_{P}. However, if at least one of the following constraints is satisfied at the selected transmission power (P), the transmission power (P) is excluded from candidate transmission power values for optimizing the target value.

First, there is a constraint related to load balancing.

VarOfCellPRBusageRatio_{Macro,CurrP}=<VarOfCellPRBusageRatio_{Macro,P} Equation 50

In Equation 50, VarOfCellPRBusageRatio_{MacroP} denotes variance of predicted PRB usage ratios of all macro cells at transmission power (P) and, at this time, a different between Equation 25 and Equation 50 for determining transmission power for load balancing is that Equation 50 does not the sign of equality. This means that load balancing of the PRB usage ratio should be better for interference control.

VarOfCellPRBusageRatio_{Pico,CurrP,k}=<VarOfCellPRBusageRatio_{Pico,P,k} Equation 51

Equation 51 above is applied only to the case in which a selected cell k is a pico cell. VarOfCellPRBusageRatio_{Pico,P,k} denotes variance of predicted PRB usage ratios of the pico cell k and neighboring cells of the pico cell k at transmission power (P). At this time, a difference between Equation 26 and Equation 51 for determining transmission power for load balancing is that Equation 51 does not include the sing of equality. This means that load balancing of the PRB usage ratio should be better for interference control.

Secondly, there is a constraint related to an SINR.

SINR_{Full,CurrP,m}>SINR_{Full,P,m} and SINR_{outage}>SINR_{Full,P,m} Equation 52

In Equation 52 above, SINR_{Full,P,m} denotes a full loading SINR of the UE m at transmission power (P), and SINR_{outage} denotes an SINR value that may generate a communication outage. This is a condition meaning that the full loading SINR of the UE m should be larger than the case of current transmission power and should be larger than the SINR value that may generate the communication outage.

Thirdly, there is a constraint related to UE throughput.

SumOfLogUETput_{Partial,CurrP}>=SumOfLogUETput_{Partial,P} Equation 53

In Equation 53 above, SumOfLogUETput_{Partial,P} denotes a sum of Log (predicted UE throughput) at transmission power (P) in a partial loading environment, which means that the sum of UE throughput should not be smaller than the current state.

Fourthly, there is a constraint related to a UE located at an edge.

NumEdgeUE_{CurrP}<NumEdgeUE_{P} Equation 54

In Equation 54 above, NumEdgeUEp denotes the predicted number of PCell UEs existing in a handover (HO) region at transmission power (P) and aims at preventing the number of handovers from being large.

If SINR_{Full,CurrP,m}>SINR_{Full,P,m} and SINR_{outage}>SINR_{Full,P,m,} the optimization server may reduce a transmission power control range of the selected cell as shown in Equation 55 below in order to prevent the communication outage. Transmission power control range of selected cell=(selected power (P) of selected

cell+1 [dB]) to maximum transmission power Equation 55

In Equation 55, the minimum value of the transmission power control range is controlled to be (currently selected transmission power+1 dB) in order to prevent the communication outage, and the optimization server controls again the transmission power within a new control range.

Hereinafter, a process of monitoring a network quality will be described.

The base station transfers handover statistics of a cell and call drop statistics to the optimization server in every transmission power control period, and the optimization server manages the handover statistics of the cell, the call drop statistics, and history information of transmission power. However, the history information remains only for a recent specific time.

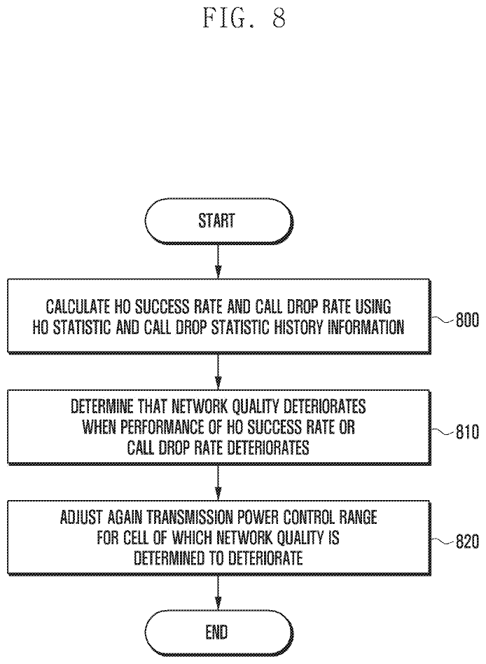

The optimization server updates a transmission power control range for each cell on the basis of network quality statistics and transmission power history information in every transmission power control period as illustrated in FIG. 8.

FIG. 8 illustrates a method by which the optimization server updates a transmission power control range by monitoring a network quality, and referring to FIG. 8, the optimization server calculates a handover success rate and a call drop rate on the basis of handover statistics and call drop statistic history information in step 800. Thereafter, the optimization server determines that the network quality deteriorates if performance of the handover success rate or the call drop rate deteriorates in step 810. The determination follows a reference of Equation 55 below.

Handover success rate<KPI_HO_SUCCESS_RATE Equation 55

Call drop rate>KPI_CALL_DROP_RATE

In Equation 55 above, KPI_HO_SUCCESS_RATE is a target value preset for the handover success rate, and KPI_CALL_DROP_RATE is a target value for the call drop rate.

Thereafter, the optimization server controls the transmission power control range for a cell of which a network quality is determined to deteriorate as shown in Equation 56 below in step 820.

Transmission power control range=(minimum transmission power [dB] within history information+1 [dB]) to maximum transmission power Equation 56

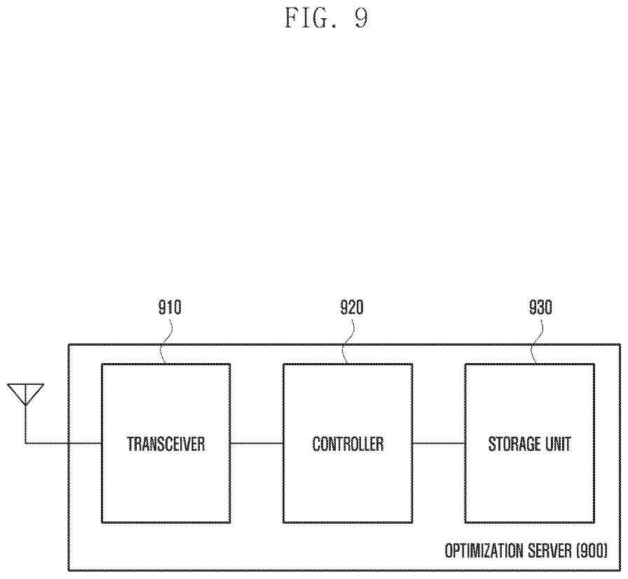

FIG. 9 is a block diagram illustrating an optimization server capable of performing the disclosure.

Referring to FIG. 9, an optimization server 900 may include a transceiver 910, a controller 920, and a storage unit 930. The transceiver may transmit and receive information to and from a system management server and a base station, and the storage unit may store information which the system management server and the base station transmit. The controller controls the transceiver and the storage unit. Further, the controller collects and transmits transmission power control-related information, determines transmission power to be applied to each cell, and monitors a network quality according to the disclosure.

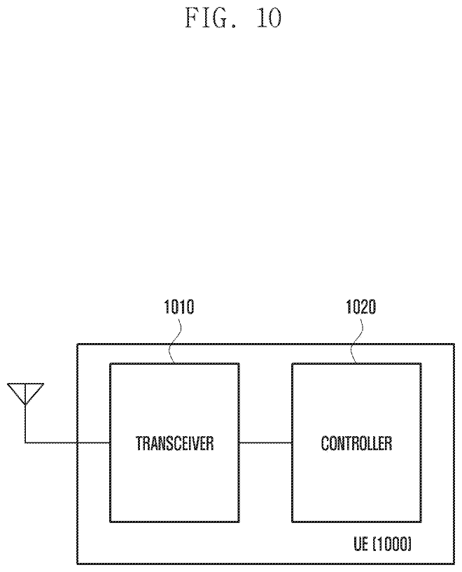

FIG. 10 is a block diagram illustrating a UE capable of performing the disclosure.

Referring to FIG. 10, a UE 1000 may include a transceiver 1010 and a controller 1020. The transceiver may transmit and receive a signal to and from a base station according to applied transmission power, and the controller may control the transceiver according to the disclosure.

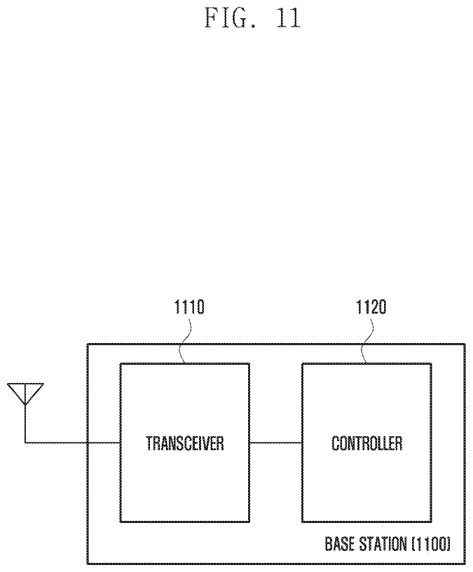

FIG. 11 is a block diagram illustrating a base station capable of performing the disclosure.

Referring to FIG. 11, a base station 1100 may include a transceiver 1110 and a controller 1120. The transceiver transmits and receives a signal to and from an optimization server and a UE, and the controller may control the transceiver according to the disclosure.

According to the above-described disclosure, it is possible to improve UE throughput through real-time transmission power control in consideration of a radio channel state for multiple carriers and multiple cells in a heterogeneous network, a loading state, and a CA operation without network quality deterioration in a CA environment.

1. A method of controlling transmission power of each cell by a server, the method comprising:
receiving configuration information from a system management server;
receiving channel state information and loading-related information from a base station controlling each cell;
determining transmission power to be applied to each cell, based on the configuration information, the channel state information, and the loading-related information; and
transmitting the determined transmission power information to the base station for controlling each cell.

2. The method of claim 1, wherein the controlling of the transmission power comprises determining a load balancing mode for determining the transmission power as one of a balancing mode of a number of UEs or a resource usage ratio balancing mode.

3. The method of claim 2, wherein the controlling of the transmission power further comprises determining a transmission power control direction of a macro cell among respective cells as a transmission power increase or a transmission power decrease.

4. The method of claim 3, wherein the controlling of the transmission power further comprises determining a transmission power value for load balancing, based on the transmission power control direction.

5. The method of claim 4, wherein the controlling of the transmission power further comprises determining a transmission power value of each cell for minimizing or maximizing a target value calculated based on assumption of a transmission power value, based on the load balancing mode and a transmission power value for the load balancing.

6. The method of claim 5, wherein the target value is a sum of throughput of all UEs when the load balancing mode is the number-of-UE balancing mode and the target value is a sum of throughput of all UEs or a sum of resource usage ratios of all UEs when the load balancing mode is the resource usage ratio balancing mode, and the transmission power value of each cell is a value for maximizing the sum of throughput of all UEs or minimizing the sum of resource usage ratios of all UEs.

7. The method of claim 1, further comprising:
receiving network quality-related statistic information from a base station for controlling each cell;
determining whether a network quality deteriorates based on the network quality-related statistic information; and
updating a transmission power control range, based on whether the network quality deteriorates.

8. A server for controlling transmission power of each cell, the server comprising:
a transceiver configured to transmit and receive a signal to and from a base station for controlling each cell and a system management server; and
a controller configured to:
receive configuration information from the system management server,
receive channel state information and loading-related information from the base station for controlling each cell,
determine transmission power to be applied to each cell, based on the configuration information, the channel state information, and the loading-related information, and
transmit the determined transmission power information to the base station for controlling each cell

9. The server of claim 8, wherein the controller further performs control to determine a load balancing mode for determining the transmission power as one of a number-of-UE balancing mode or a resource usage ratio balancing mode.

10. The server of claim 9, wherein the controller further performs control to determine a transmission power control direction of a macro cell among respective cells as a transmission power increase or a transmission power decrease.

11. The server of claim 10, wherein the controller further performs control to determine a transmission power value for load balancing, based on the transmission power control direction.

12. The server of claim 11, wherein the controller further performs control to determine a transmission power value of each cell for minimizing or maximizing a target value calculated based on assumption of a transmission power value, based on the load balancing mode and a transmission power value for the load balancing.

13. The server of claim 12, wherein the target value is a sum of throughput of all UEs when the load balancing mode is the number-of-UE balancing mode and the target value is a sum of throughput of all UEs or a sum of resource usage ratios of all UEs when the load balancing mode is the resource usage ratio balancing mode, and the transmission power value of each cell is a value for maximizing the sum of throughput of all UEs or minimizing the sum of resource usage ratios of all UEs.

14. The server of claim 8, wherein the controller further performs control to receive network quality-related statistic information from a base station for controlling each cell, determine whether a network quality deteriorates based on the network quality-related statistic information, and update a transmission power control range, based on whether the network quality deteriorates.
